(19) United States
(12) Patent Application Publication
(10) Pub. No.: US 2005/0035970 A1
(43) Pub. Date: Feb. 17, 2005

(54) Methods and apparatuses for authoring declarative content for a remote platform

(76) Inventors: Jenny Dana Wirtschafter, Mountain View, CA (US); Christopher F. Marrin, Los Altos, CA (US); Peter Broadwell, Palo Alto, CA (US)

Correspondence Address: Richard H. Butler, 5655 Silver Creek Valley Road, #106, San Jose, CA, 95138, US

(21) Appl. No.: 10/938,106

(22) Filed: Sep. 9, 2004

Related U.S. Application Data
(63) Continuation-in-part of application No. 10/712,858, filed on Nov. 12, 2003.
Application No. 10/712,858 is a continuation of application No. 09/632,351, filed on Aug. 3, 2000, now Pat. No. 6,707,456.
(63) Continuation-in-part of application No. 09/632,350, filed on Aug. 3, 2000.
(60) Provisional application No. 60/146,972, filed on Aug. 3, 1999.
(60) Provisional application No. 60/147,092, filed on Aug. 3, 1999.

(51) Int. Cl. G06T 13/00

(52) U.S. Cl. 345/473

(57) ABSTRACT

In one embodiment, the methods and apparatuses transmit authored content from an authoring device to a remote device; directly play the authored content on the remote device; and monitor a portion of the authored content on the authoring device while simultaneously playing the portion of the authored content on the remote device, wherein the authored content is scripted in a declarative markup language.

### CROSS REFERENCE TO RELATED APPLICATIONS

This application is a continuation-in-part of application Ser. No.10/712,858 filed on Nov. 12, 2003, which is a continuation of application Ser. No. 09/632,351 filed on Aug. 3, 2000 (now issued U.S. Pat. No. 6,607,456), which claims benefit of U.S Provisional Application No. 60/146,972 filed on Aug. 3,1999. This application is a continuation-in-part of application Ser. No. 09/632,350 filed on Aug. 3, 2000, which claims benefit of U.S Provisional Application No. 60/147,092 filed on Aug. 3,1999. Both disclosures for U.S. patent application Ser. No. 10/712,858 and U.S. patent application Ser. No. 09/632,350 are hereby incorporated by reference.

### FIELD OF THE INVENTION

The present invention relates generally to authoring declarative content and, more particularly, to authoring declarative content for a remote platform.

### BACKGROUND

Authoring content for a variety of target devices such as gaming consoles, cellular phones, personal digital assistants, and the like are typically done on an authoring device platform. By utilizing a widely used platform such as a personal computer running Windows®, the author is able to utilize widely available tools for creating, editing, and modifying the authored content. In some cases, these target devices have unique and proprietary platforms that are not interchangeable with the authoring device platform. Utilizing a personal computer as the authoring device to create content is often easier than authoring content within the platform of the target device; many additional tools and resources are typically available on a personal computer platform that is unavailable on the platform of the target device.

Viewing the authored content on the actual target device is often needed for debugging and fine-tuning the authored content. However, transmitting the authored content from the authoring device platform to the target device platform sometimes requires the authored content to be transmitted in the form of a binary executable which is recompiled on the actual target device before the authored content can be viewed on the actual target device. The additional step of recompiling the binary executable code delays viewing the authored content on the target device.

Debugging and fine-tuning the authored content on the authoring device platform is often advantageous compared to modifying the authored content on the target device platform. Unfortunately, utilizing a binary executable on the target device hinders the author's ability to debug and fine tune the authored content on the authoring device platform.

### SUMMARY

In one embodiment, the methods and apparatuses transmit authored content from an authoring device to a remote device; directly play the authored content on the remote device; and monitor a portion of the authored content on the authoring device while simultaneously playing the portion of the authored content on the remote device, wherein the authored content is scripted in a declarative markup language.

### BRIEF DESCRIPTION OF THE DRAWINGS

The accompanying drawings, which are incorporated in and constitute a part of this specification, illustrate and explain one embodiment of the methods and apparatuses for authoring declarative content for a remote platform. In the drawings,

FIG. 1 is a diagram illustrating an environment within which the methods and apparatuses for authoring declarative content for a remote platform are implemented;

FIG. 2 is a simplified block diagram illustrating one embodiment in which the methods and apparatuses for authoring declarative content for a remote platform are implemented;

FIG. 3 is a simplified block diagram illustrating a system, consistent with one embodiment of the methods and apparatuses for authoring declarative content for a remote platform;

FIG. 4 is a simplified block diagram illustrating a system, consistent with one embodiment of the methods and apparatuses for authoring declarative content for a remote platform;

FIG. 5 is a flow diagram consistent with one embodiment of the methods and apparatuses for authoring and modifying declarative content for a remote platform;

FIG. 6 is a flow diagram consistent with one embodiment of the methods and apparatuses for authoring and modifying declarative content for a remote platform;

FIG. 7A is a timing diagram illustrating one embodiment in which the methods and apparatuses for authoring declarative content for a remote platform are implemented;

FIG. 7B is a timing diagram illustrating one embodiment in which the methods and apparatuses for authoring declarative content for a remote platform are implemented;

FIG. 8 is a simplified block diagram illustrating one embodiment in which the methods and apparatuses for authoring declarative content for a remote platform are implemented;

FIG. 9 is a flow diagram consistent with one embodiment of the methods and apparatuses for authoring and modifying declarative content for a remote platform;

FIG. 10 is a simplified block diagram illustrating one embodiment in which the methods and apparatuses for authoring declarative content for a remote platform are implemented; and

FIG. 11 is a flow diagram consistent with one embodiment of the methods and apparatuses for authoring and modifying declarative content for a remote platform.

### DETAILED DESCRIPTION

The following detailed description of the methods and apparatuses for authoring declarative content for a remote platform refers to the accompanying drawings. The detailed description is not intended to limit the methods and apparatuses for authoring declarative content for a remote platform. Instead, the scope of the methods and apparatuses for authoring declarative content for a remote platform are defined by the appended claims and equivalents. Those skilled in the art will recognize that many other implementations are possible, consistent with the present invention.

References to a “device” include a device utilized by a user such as a computer, a portable computer, a personal digital assistant, a cellular telephone, a gaming console, and a device capable of processing content.

References to “content” include graphical representations both static and dynamic scenes, audio representations, and the like.

References to “scene” include a content that is configured to be presented in a particular manner.

In one embodiment, the methods and apparatuses for authoring declarative content for a remote platform allows an authoring device to create content for use on a remote device. In one embodiment, the authoring device utilizes well known tools and interfaces to create the content. For example, exemplary authoring devices include personal computers such as Windows®, Apple®, and Linux® based personal computers. In one embodiment, the remote device is configured to utilize the content authored via the authoring device. For example, exemplary remote devices are game consoles utilizing Sony PlayStation® applications.

In one embodiment, the authoring device utilizes a declarative language to create the authored content. One such declarative language is illustrated with code snippets shown within the specification. Through the use of a declarative language, the authored content may be scripted directly from the authoring device. Further, the authored content that is created on the authoring device is specifically developed for use on the remote device. In one example, the authored content created on a personal computer is configured to be utilized on a gaming console.

In one embodiment, the methods and apparatuses for authoring declarative content for a remote platform allows the remote device to directly utilize the authored content created on the authoring device. Further, the authored content is transmitted from the authoring device and played directly on the remote device without re-compiling on the remote device. For example, a portion of the authored content may be simultaneously played while streaming the authored content from the authoring device to the remote device. By playing the authored content directly on the remote device, modifying and debugging the authored content on the authoring device is possible.

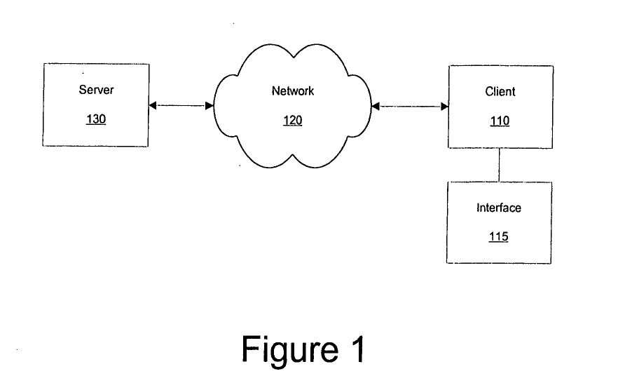

FIG. 1 is a diagram illustrating an environment within which the methods and apparatuses for authoring declarative content for a remote platform are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of authoring declarative content for a remote platform below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

In one embodiment, the electronic device 110 is the remote device configured to receive authored content via the network 120. In another embodiment, the electronic device 110 is an authoring device configured to transmit authored content for the remote device via the network 120.

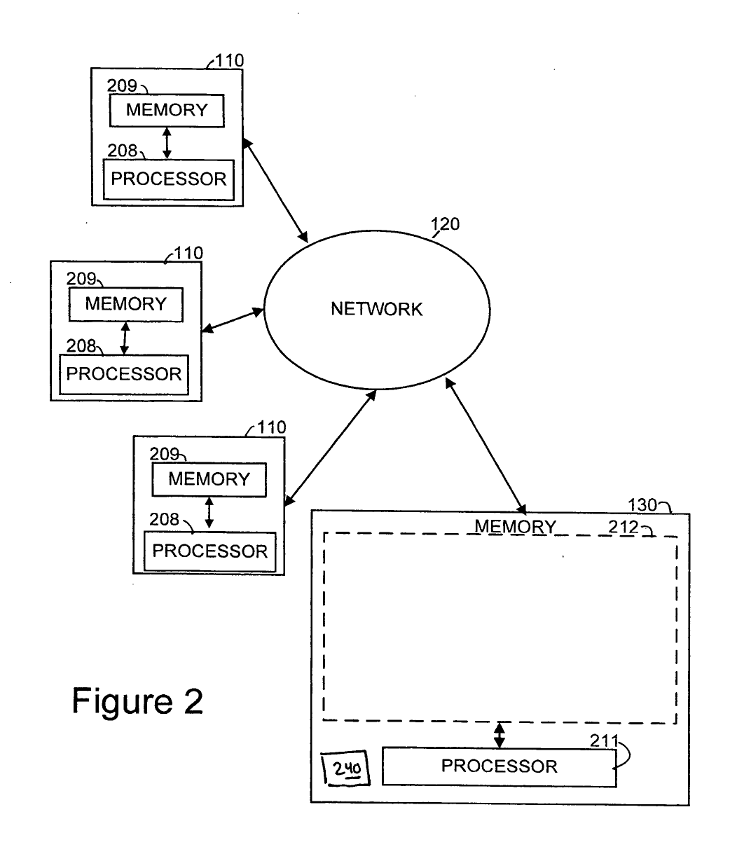

FIG. 2 is a simplified diagram illustrating an exemplary architecture in which the methods and apparatuses for authoring declarative content for a remote platform are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 110 and the server 130 include instructions for authoring declarative content for a remote platform. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on authoring declarative content for a remote platform as determined using embodiments described below.

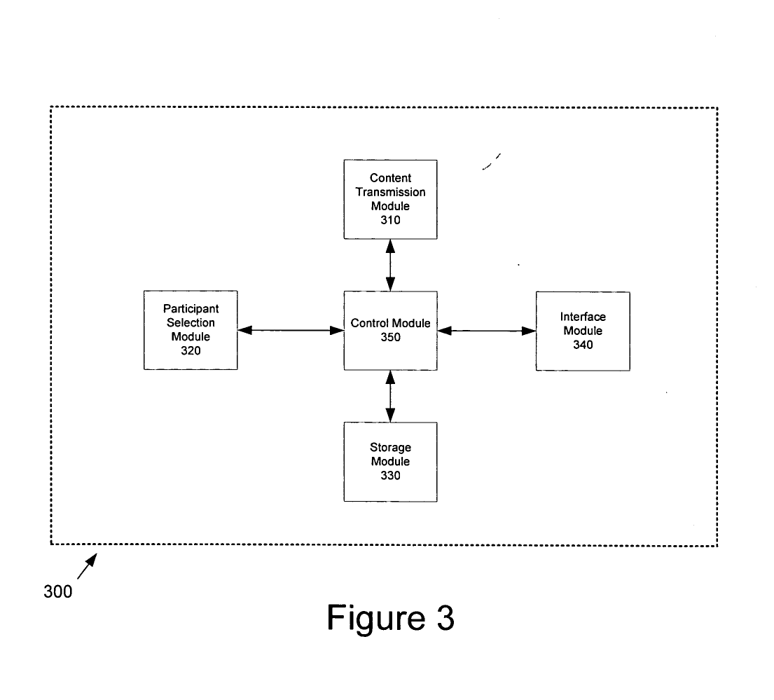

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a content transmission module 310, a content detection module 320, a storage module 330, an interface module 340, and a control module 350.

In one embodiment, the control module 350 communicates with the content transmission module 310, the content detection module 320, a storage module 330, and the interface module 340. In one embodiment, the control module 350 coordinates tasks, requests, and communications between the content transmission module 310, the content detection module 320, a storage module 330, and the interface module 340.

In one embodiment, the content transmission module 310 detects authored content created by an authoring device and transmits the authored content to the detected remote device. In one embodiment, the remote device is a device that is especially configured to utilize the authored content such as a gaming console, a cellular telephone, a set top box, or other device.

In one embodiment, the content detection module 320 monitors the use of the authored content as utilized by the remote device from the authoring device. By monitoring the authored content while being utilized on the remote device, refining and modifying the authored content with the authoring device is possible. Further, monitoring the authored content in nearly real-time on the remote device also makes refining and modifying the authored content on the authoring device more convenient. For example, the remote device may simultaneously monitor the authored content while additional authored content is streamed to the remote device from the authoring device.

In one embodiment, the storage module 330 stores the authored content. In one embodiment, the authored content is stored as a declarative language in which the outcome of the scene is described explicitly. Further, the authored content is compatible with the remote device and is utilized by the remote device without re-compiling the authored content.

In one embodiment, the interface module 340 receives a signal from one of the electronic devices 110 indicating transmission of the authored content from the authoring device to the remote device via the system 300. In another embodiment, the interface module 340 receives a signal from one of the electronic devices 110 indicating use of the authored content on the remote device. In yet another embodiment, the interface module 340 receives signals responsive to monitoring the authored content on the authoring device while the authored content is utilized on the remote device. Further, the interface module 340 allows the authoring device to control the playback of the authored content located on the remote device.

The system 300 in FIG. 3 is shown for exemplary purposes and is merely one embodiment of the methods and apparatuses for authoring declarative content for a remote platform. Additional modules may be added to the system 300 without departing from the scope of the methods and apparatuses for authoring declarative content for a remote platform. Similarly, modules may be combined or deleted without departing from the scope of the methods and apparatuses for authoring declarative content for a remote platform.

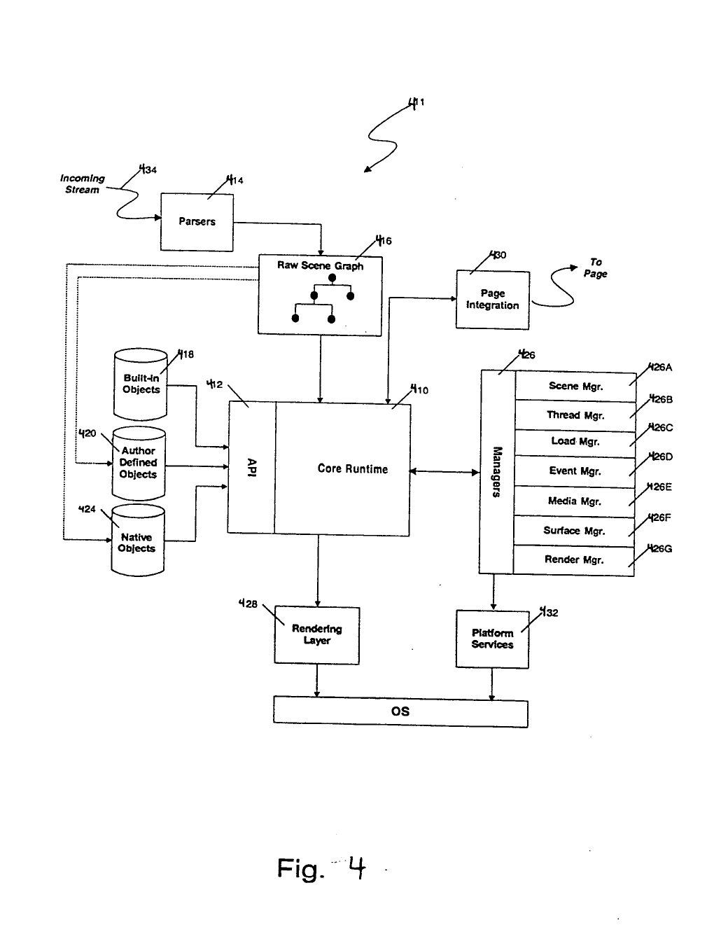

FIG. 4 illustrates an exemplary system 411 for utilizing a declarative language for use as the authored content within the system 300.

In one embodiment, the system 411 includes a core runtime module 410 which presents various Application Programmer Interface (API hereafter) elements and the object model to a set of objects present in the system 411. In one instance, a file is parsed by parser 414 into a raw scene graph 416 and passed on to the core runtime module 410, where its objects are instantiated and a runtime scene graph is built.

The objects can be stored within built-in objects 418, author defined objects 420, native objects 424, or the like. In one embodiment, the objects use a set of available managers 426 to obtain platform services 432. These platform services 432 include event handling, loading of assets, playing of media, and the like. In one embodiment, the objects use rendering layer 428 to compose intermediate or final images for display.

In one embodiment, a page integration component 430 is used to interface the authored content within the system 411 to an external environment, such as an HTML or XML page. In another embodiment, the external environment includes other platforms such as gaming consoles, cellular telephones, and other hand-held devices.

In one embodiment, the system 411 contains a system object with references to the set of managers 426. Each manager 426 provides the set of APIs to control some aspect of system 411. An event manager 426D provides access to incoming system events originated by user input or environmental events. A load manager 426C facilitates the loading of the authored content files and native node implementations. A media manager 426E provides the ability to load, control and play audio, image and video media assets. A render manager 426G allows the creation and management of objects used to render scenes. A scene manager 426A controls the scene graph. A surface manager 426F allows the creation and management of surfaces onto which scene elements and other assets may be composited. A thread manager 426B gives authors the ability to spawn and control threads and to communicate between them.

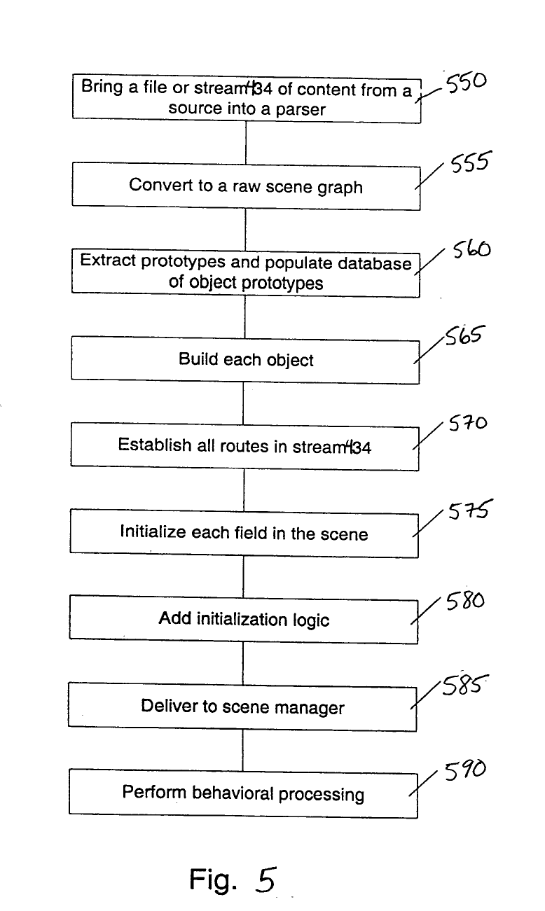

FIG. 5 illustrates in a flow diagram, a conceptual description of the flow of content through the system 411. The blocks within the flow diagram can be performed in a different sequence without departing from the spirit of the methods and apparatuses for posting messages to participants of an event. Further, blocks can be deleted, added, or combined without departing from the spirit of the methods and apparatuses for authoring declarative content for a remote platform.

In Block 550, a presentation begins with a source which includes a file or stream 434 (FIG. 4) of content being brought into parser 414 (FIG. 4). The source could be in a native VRML-like textual format, a native binary format, an XML based format, or the like. Regardless of the format of the source, in Block 555, the source is converted into raw scene graph 416 (FIG. 4). The raw scene graph 416 represents the nodes, fields and other objects in the content, as well as field initialization values. The raw scene graph 416 also can contain a description of object prototypes, external prototype references in the stream 434, and route statements.

The top level of the raw scene graph 416 includes nodes, top level fields and functions, prototypes and routes contained in the file. In one embodiment, the system 411 allows fields and functions at the top level in addition to traditional elements. In one embodiment, the top level of the raw scene graph 416 is used to provide an interface to an external environment, such as an HTML page. In another embodiment, the top level of the raw scene graph 416 also provides the object interface when a stream 434 is used as the authored content of the remote device.

In one embodiment, each raw node includes a list of the fields initialized within its context. In one embodiment, each raw field entry includes the name, type (if given) and data value(s) for that field. In one embodiment, each data value includes a number, a string, a raw node, and/or a raw field that can represent an explicitly typed field value.

In Block 560, the prototypes are extracted from the top level of raw scene graph 416 and used to populate the database of object prototypes accessible by this scene.

The raw scene graph 416 is then sent through a build traversal. During this traversal, each object is built (Block 565), using the database of object prototypes.

In Block 570, the routes in stream 434 are established. Subsequently, in Block 575, each field in the scene is initialized. In one embodiment, the initialization is performed by sending initial events to non-default fields of objects. Since the scene graph structure is achieved through the use of node fields, Block 575 also constructs the scene hierarchy as well.

In one embodiment, events are fired using in order traversal. The first node encountered enumerates fields in the node. If a field is a node, that node is traversed first. As a result of the node field being traversed, the nodes in that particular branch of the tree are also initialized. Then, an event is sent to that node field with the initial value for the node field.

After a given node has had its fields initialized, the author is allowed to add initialization logic (Block 580) to prototyped objects to ensure that the node is fully initialized at call time. The Blocks described above produce a root scene. In Block 585 the scene is delivered to the scene manager 426A (FIG. 4) created for the scene.

In Block 590, the scene manager 426A is used to render and perform behavioral processing either implicitly or under author control. In one embodiment, a scene rendered by the scene manager 426A is constructed using objects from the built-in objects 418, author defined objects 420, and native objects 424. Exemplary objects are described below.

In one embodiment, objects may derive some of their functionality from their parent objects that subsequently extend or modify their functionality. At the base of the hierarchy is the object. In one embodiment, the two main classes of objects are a node and a field. Nodes typically contain, among other things, a render method, which gets called as part of the render traversal. The data properties of nodes are called fields. Among the object hierarchy is a class of objects called timing objects, which are described in detail below. The following code portions are for exemplary purposes. It should be noted that the line numbers in each code portion merely represent the line numbers for that particular code portion and do not represent the line numbers in the original source code.

Surface Objects

A Surface Object is a node of type SurfaceNode. In one embodiment, a SurfaceNode class is the base class for all objects that describe a two-dimensional image as an array of color, depth, and opacity (alpha) values. SurfaceNodes are used primarily to provide an image to be used as a texture map. Derived from the SurfaceNode class are MovieSurface, Imagesurface, MatteSurface, PixelSurface and SceneSurface.

The following code portion illustrates the MovieSurface node.

1) MovieSurface: SurfaceNode TimedNode AudioSourceNode {

| | |
|---|---|
| 2) field MF String url | [symbol] |
| 3) field TimeBaseNode timeBase | NULL |

| | |
|---|---|
| 4) field Time duration | 0 |
| 5) field Time loadTime | 0 |
| 6) field String loadStatus | “NONE” |
| } | |

A MovieSurface node renders a movie or a series of static images on a surface by providing access to the sequence of images defining the movie. The MovieSurface's TimedNode parent class determines which frame is rendered onto the surface at any given time. Movies can also be used as sources of audio.

In line 2 of the code portion, (“Multiple Value Field) the URL field provides a list of potential locations of the movie data for the surface. The list is ordered such that element 0 describes the preferred source of the data. If for any reason element 0 is unavailable, or in an unsupported format, the next element may be used.

In line 3, the timeBase field, if specified, specifies the node that is to provide the timing information for the movie. In particular, the timeBase field provides the movie with the information needed to determine which frame of the movie to display on the surface at any given instant. In one embodiment, if no timeBase is specified, the surface will display the first frame of the movie.

In line 4, the duration field is set by the MovieSurface node to the length of the movie in seconds once the movie data has been fetched.

In lines 5 and 6, the loadTime and the loadStatus fields provide information from the MovieSurface node concerning the availability of the movie data. LoadStatus has five possible values, “NONE”, “REQUESTED”, “FAILED”, “ABORTED”, and “LOADED”.

“NONE” is the initial state. A “NONE' event is also sent if the node's url is cleared by either setting the number of values to 0 or setting the first URL string to the empty string. When this occurs, the pixels of the surface are set to black and opaque (i.e. color is 0,0,0 and transparency is 0).

A “REQUESTED” event is sent whenever a non-empty url value is set. The pixels of the surface remain unchanged after a “REQUESTED” event.

“FAILED” is sent after a “REQUESTED” event if the movie loading did not succeed. This can happen, for example, if the UIRL refers to a non-existent file or if the file does not contain valid data. The pixels of the surface remain unchanged after a “FAILED” event.

An “ABORTED” event is sent if the current state is “REQUESTED” and then the URL changes again. If the URL is changed to a non-empty value, “ABORTED” is followed by a “REQUESTED” event. If the URL is changed to an empty value, “ABORTED” is followed by a “NONE” value. The pixels of the surface remain unchanged after an “ABORTED” event.

A “LOADED” event is sent when the movie is ready to be displayed. It is followed by a loadTime event whose value matches the current time. The frame of the movie indicated by the timeBase field is rendered onto the surface. If timeBase is NULL, the first frame of the movie is rendered onto the surface.

The following code portion illustrates the ImageSurface node.

| 1) ImageSurface: SurfaceNode{ | |
|---|---|
| 2) field MF String | url [symbol] |
| 3) field Time loadTime | 0 |
| 4) field String loadStatus | “NONE” |
| } | |

An ImageSurface node renders an image file onto a surface. In line 2 of the code portion, the URL field provides a list of potential locations of the image data for the surface. The list is ordered such that element 0 describes the most preferred source of the data. If for any reason element 0 is unavailable, or in an unsupported format, the next element may be used. In lines 3 and 4, the loadTime and the loadStatus fields provide information from the ImageSurface node concerning the availability of the image data. LoadStatus has five possible values such as “NONE”, “REQUESTED”, “FAILED”, “ABORTED”, and “LOADED”.

The following code portion illustrates the MatteSurface node.

| 1) MatteSurface: SurfaceNode { | |
|---|---|
| 2) field SurfaceNode surfacel | NULL |
| 3) field SurfaceNode surface2 | NULL |
| 4) field String operation | |
| 5) field MF Float parameter | 0 |
| 6) field Bool overwriteSurface2 | FALSE |
| } | |

The MatteSurface node uses image compositing operations to combine the image data from surface 1 and surface 2 onto a third surface. The result of the compositing operation is computed at the resolution of surface 2. If the size of surface I differs from that of surface 2, the image data on surface I is zoomed up or down before performing the operation to make the size of surface 1 equal to the size of surface 2.

In lines 2 and 3 of the code portion, the surface I and surface 2 fields specify the two surfaces that provide the input image data for the compositing operation. In line 4, the operation field specifies the compositing function to perform on the two input surfaces. Possible operations include “REPLACE_ALPHA”, “MULTIPLY_ALPHA”, “CROSS_FADE”, and “BLEND”.

“REPLACE_ALPHA” overwrites the alpha channel A of surface 2 with data from surface 1. If surface 1 has a component (grayscale intensity only), that component is used as the alpha (opacity) values. If surface 1 has two or four components (grayscale intensity+alpha or RGBA), the alpha channel A is used to provide the alpha values. If surface 1 has three components (RGB), the operation is undefined. This operation can be used to provide static or dynamic alpha masks for static or dynamic images. For example, a SceneSurface could render an animated James Bond character against a transparent background. The alpha component of this image could then be used as a mask shape for a video clip.

“MULTIPLY_ALPHA” is similar to REPLACE_ALPHA. except that the alpha values from surface I are multiplied with the alpha values from surface 2.

“CROSS_FADE” fades between two surfaces using a parameter value to control the percentage of each surface that is visible. This operation can dynamically fade between two static or dynamic images. By animating the parameter value (line 5) from 0 to 1 the image on surface 1 fades into that of surface 2.

“BLEND” combines the image data from surface I and surface 2 using the alpha channel from surface 2 to control the blending percentage. This operation allows the alpha channel of surface 2 to control the blending of the two images. By animating the alpha channel of surface 2 by rendering a SceneSurface or playing a MovieSurface, a complex traveling matte effect can be produced. If R1, G1, B1, and Al represent the red, green, blue, and alpha values of a pixel of surface I and R2, G2, B2, and A2 represent the red, green, blue, and alpha values of the corresponding pixel of surface 2, then the resulting values of the red, green, blue, and alpha components of that pixel are:
red=RI*(1−A2)+R2*A2 (1)
green=GI*(1−A2)+G2*A2 (2)
blue=B1*(1−A2)+B2*A2 (3)
alpha=1 (4)
“ADD” and “SUBTRACT” add or subtract the color channels of surface 1 and surface 2. The alpha of the result equals the alpha of surface 2.

In line 5, the parameter field provides one or more floating point parameters that can alter the effect of the compositing function. The specific interpretation of the parameter values depends upon which operation is specified.

In line 6, the overwrite surface 2 field indicates whether the MatteSurface node should allocate a new surface for storing the result of the compositing operation (overwriteSurface2=FALSE) or whether the data stored on surface 2 should be overwritten by the compositing operation (overwriteSurface2=TRUE).

The following code portion illustrates the SceneSurface node.

1) PixelSurface: SurfaceNode {
2)field Image image 0 0 0
}

A PixelSurface node renders an array of user-specified pixels onto a surface. In line 2, the image field describes the pixel data that is rendered onto the surface.

The following code portion illustrates the use of SceneSurface node.

1) SceneSurface: SurfaceNode {
2) field MF ChildNode children [symbol]
3) field UInt32 width
4) field UInt32 height 1
}

A SceneSurface node renders the specified children on a surface of the specified size. The SceneSurface automatically re-renders itself to reflect the current state of its children.

In line 2 of the code portion, the children field describes the ChildNodes to be rendered. Conceptually, the children field describes an entire scene graph that is rendered independently of the scene graph that contains the SceneSurface node.

In lines 3 and 4, the width and height fields specify the size of the surface in pixels. For example, if width is 256 and height is 512, the surface contains a 256×512 array of pixel values.

In some embodiments, the MovieSurface, Imagesurface, MatteSurface, PixelSurface, and SceneSurface nodes are utilized in rendering a scene.

At the top level of the scene description, the output is mapped onto the display, the “top level Surface.” Instead of rendering its results to the display, the three dimensional rendered scene can generate its output onto a surface using one of the above mentioned SurfaceNodes, where the output is available to be incorporated into a richer scene composition as desired by the author. The contents of the surface, generated by rendering the surface's embedded scene description, can include color information, transparency (alpha channel) and depth, as part of the surface's structured image organization. An image, in this context is defined to include a video image, a still image, an animation or a scene.

A surface is also defined to support the specialized requirements of various texture-mapping systems that are located internally, behind a common image management interface. As a result, any surface producer in the system can be consumed as a texture by the three dimensional rendering process. Examples of such surface producers include an ImageSurface, a MovieSurface, a MafteSurface, a SceneSurface, and an ApplicationSurface.

An ApplicationSurface maintains image data as rendered by its embedded application process, such as a spreadsheet or word processor, a manner analogous to the application window in a traditional windowing system.

The integration of surface model with rendering production and texture consumption allows declarative authoring of decoupled rendering rates. Traditionally, three dimensional scenes have been rendered monolithically, producing a final frame rate to the viewer that is governed by the worst-case performance due to scene complexity and texture swapping. In a real-time, continuous composition framework, the surface abstraction provides a mechanism for decoupling rendering rates for different elements on the same screen. For example, it may be acceptable to portray a web browser that renders slowly, at perhaps 1 frame per second, but only as long as the video frame rate produced by another application and displayed alongside the output of the browser can be sustained at a full 30 frames per second.

If the web browsing application draws into its own surface, then the screen compositor can render unimpeded at full motion video frame rates, consuming the last fully drawn image from the web browser's surface as part of its fast screen updates.

Timing Objects

Timing objects include a TimeBase node. This is included as a field of a timed node and supplies a common set of timing semantics to the media. Through node instancing, the TimeBase node can be used for a number of related media nodes, ensuring temporal synchronization. A set of nodes including the Score node is utilized for sequencing media events. The Score node is a timed node and derives its timing from a TimeBase. The Score node includes a list of Cue nodes, which emit events at the time specified. Various timing objects, including Score, are described below.

The following code portion illustrates the TimeNode node. A description of the functions in the node follows thereafter.

```
1)  TimedNode ChildNode {
2)  field TimeBaseNode timeBase NULL
3)  function Time getduration( )
4)  function void updateStartTime(Time now, Time mediaTime,
Float rate)
    5)  function void updateStopTime(Time now, Time mediaTime,
Float rate)
    6)  function void updateMediaTime(Time now, Time mediaTime,
Float rate)
    }
```

This object is the parent of all nodes controlled by a TimeBaseNode. In line 2 of the code portion, the TimeBase field contains the controlling TimeBaseNode, which makes the appropriate function calls listed below when the time base starts, stops or advances.

In line 3, the getDuration function returns the duration of the TimedNode. If unavailable, a value of −1 is returned. This function is typically overridden by derived objects.

Line 4 lists the updateStartTime function. When called, this function starts advancing its related events or controlled media, with a starting offset specified by the mediaTime value. The updateStartTime function is typically overridden by derived objects.

Line 5 lists the updateStopTime function, which when called, stops advancing its related events or controlled media. This function is typically overridden by derived objects.

In line 6, the updateMediaTime function is called whenever mediaTime is updated by the TimeBaseNode. The updateMediaTime function is used by derived objects to exert further control over their media or send additional events.

The following code portion illustrates the IntervalSensor node.

1) IntervalSensor : TimedNode {
2) field TimecycleInterval 1
3) field Float fraction 0
4) field Float time 0
}

The IntervalSensor node generates events as time passes. IntervalSensor node can be used for many purposes including but not limited to drive continuous simulations and animations; to control periodic activities (e.g., one per minute); and to initiate single occurrence events such as an alarm clock.

The IntervalSensor node sends initial fraction and time events when its updateStartTime( ) function is called. In one embodiment, this node also sends a fraction and time event every time updateMediaTime( ) is called. Finally, final fraction and time events are sent when the updateStopTimeO function is called.

In line 2 of the code portion, the cyclelnterval field is set by the author to determine the length of time, measured in seconds, it takes for the fraction to go from 0 to 1. This value is returned when the getDuration( ) function is called.

Line 3 lists the fraction field, which generates events whenever the TimeBaseNode is running using equation (1) below:
fraction=max(min(mediaTime/cyclelnterval, 1), 0) Eqn. (1)

Line 4 lists the time field, which generates events whenever the TimeBaseNode is running. The value of the time field is the current wall clock time.

The following code portion illustrates the Score node.

1) Score : TimedNode{
2) field ME CueNode cue [symbol]
}

This object calls each entry in the cue field for every updateStartTime( ), updateMediaTime( ), and updateStopTime( ) call received. Calls to each cue entry returns the currently accumulated relative time. This value is passed to subsequent cue entries to allow relative offsets between cue entries to be computed.

In line 2 of the code portion, the cuefield holds the list of CueNode entries to be called 20 with the passage of mediatime.

The following code portion illustrates the TimeBaseNode node.

1) TimeBaseNode : Node {
2) field Time mediaTime 0
3) function void evaluate(Time time)
4) function void addClient(TimedNode node)
5) function void removeClient(TimedNode node)
6) function 1nt32 getNumClients 0
7) function TimedNode getClient(1nt32 index)
}

This object is the parent of all nodes generating mediaTime. Line 2 of the code portion lists the mediaTime field, which generates an event whenever mediaTime advances. MediaTime field is typically controlled by derived objects.

Line 3 lists the evaluate function, which is called by the scene manager when time advances if this TimeBaseNode has registered interest in receiving time events.

Line 4 lists addClient function, which is called by each TimedNode when this TimeBaseNode is set in their timeBase field. When mediaTime starts, advances or stops, each client in the list is called. If the passed node is already a client, this function performs no operations.

Line 5 lists the removeClient function, which is called by each TimedNode when this TimeBaseNode is no longer set in their timeBase field. If the passed node is not in the client list, this function performs no operations.

Line 6 lists the getNumClients function, which returns the number of clients currently in the client list.

Line 7 lists the getclient function, which returns the client at the passed index. If the index is out of range, a NULL value is returned.

The following code portion illustrates the TimeBase node.

| 1) TimeBase : TimeBaseNode { | |
|---|---|
| 2) field Bool loop false | |
| 3) field Time startTime 0 | |
| 4) field Time playTime0 | |
| 5) field Time stopTime 0 | |
| 6) field Time | mediastartTime 0 |
| 7) field Time | mediaStopTime 0 |
| 8) field Float rate | 1 |
| 9) field Time duration | 0 |
| 10) field Bool enabled | true |
| 11) field fool isActive | false |
| } | |

This object controls the advancement of mediaTime. TimeBase can start, stop and resume this value, as well as make mediaTime loop continuously. Time Base allows mediaTime to be played over a subset of its range.

In line 2 of the code portion, the loop field controls whether or not mediaTime repeats its advancement when mediaTime reaches the end of its travel.

In line 3, the startTime field controls when mediaTime starts advancing. When startTime, which is in units of wall clock time, is reached the TimeBase begins running. This is true as long as stoptime is less than startTime. When this occurs mediaTime is set to the value of mediastartTime if rate is greater than or equal to 0. If mediaStartTime is out of range (see mediaStartTime for a description of its valid range), mediatime is set to 0. If the rate is less than 0, mediaTime is set to mediaStopTime. If mediaStopTime is out of range, mediatime is set to duration. The TimeBase continues to run until stopTime is reached or mediaStopTime is reached (mediastartTime if rate is less than 0). If a startTime event is received while the TimeBase is running, it is ignored.

In lines 4 and 5, the playTime field behaves identically to startTime except that mediaTime is not reset upon activation. The playTime field allows mediaTime to continue advancing after the TimeBase is stopped with stopTime. If both playTime and startTime have the same value, startTime takes precedence. If a playTime event is received while the TimeBase is running, the event is ignored. The stopTime field controls when the TimeBase stops.

In line 6, the mediastartTime field sets the start of the sub range of the media duration over which mediaTime shall run. The range of mediastartTime is from zero to the end of the duration (0 . . . duration). If the value of mediaStartTime field is out of range, 0 is used in its place.

In line 7, the mediaStopTime field sets the end of the sub range of the media duration over which mediaTime runs. The range of mediaStopTime is from zero to the end of the duration (0 . . . duration). If the value of mediaStopTime is out of range, the duration value is used in its place.

In line 8, the rate field allows mediaTime to run at a rate other than one second per second of wall clock time. The rate provided in the rate field is used as an instantaneous rate. When the evaluate function is called, the elapsed time since the last call is multiplied by rate and the result is added to the current mediaTime.

In line 9, the duration field generates an event when the duration of all clients of this TimeBase have determined their duration. The value of the duration field is the same as the client with the longest duration.

In line 10, the enabled field enables the TimeBase. When enabled goes false, isActive goes false if it was true and mediatime stops advancing. While false, startTime and playTime are ignored. When enabled field goes true, startTime and playTime are evaluated to determine if the TimeBase should begin running. If so, the behavior as described in starttime or playTime is performed.

Line 11 lists the isActive field, which generates a true event when the TimeBase becomes active and a false event when the timefalse becomes inactive.

The following code snippet illustrates the CueNode node.

```
      1)  CueNode: Node {
      2)  field Float offset −1
      3)  field float delay  0
      4)  field Bool enabled true
      5)  field Int32 direction 0
      6)  function void updateStartTime(Time now, Time mediaTime,
Float rate)
      7)  function void updateStopTime(Time now, Time mediaTime,
Float rate)
      8)  function Time evaluate(Time accumulated, Time now, Time
mediaTime, Float rate)
      9)  function Time getAccumulatedTime(Time accumulated)
    10)  function void fire(Time now, Time mediaTime)
```

This object is the parent for all objects in the Score's cue list. In line 2 of the code portion, the offset field establishes a 0 relative offset from the beginning of the sequence. For instance, a value of 5 will fire the CueNode when the incoming mediaTime reaches a value of 5.

In line 3, the delay field establishes a relative delay before the CueNode fires. If offset is a value other than −1 (the default), this delay is measured from offset. Otherwise the delay is measured from the end of the previous CueNode or from 0 if this is the first CueNode. For instance, if offset has a value of 5 and delay has a value of 2, this node will fire when mediaTime reaches 7. If offset has a value of −1 and delay has a value of 2, this node will fire 2 seconds after the previous CueNode ends.

In line 4, if the enabled field is false, the CueNode is disabled. The CueNode behaves as though offset and delay were their default values and it does not fire events. If it is true, the CueNode behaves normally.

In line 5, the direction field controls how this node fires relative to the direction of travel of mediaTime. If this field is 0, this node fires when this node's offset and/or delay are reached, whether mediaTime is increasing (rate greater than zero) or decreasing (rate less than zero). If direction field is less than zero, this node fires only if its offset and/or delay are reached when mediaTime is decreasing. If direction field is greater than zero, this node fires only if this node's offset and/or delay are reached when mediaTime is increasing.

Line 6 lists the updateStartTime function, which is called when the parent Score receives an updateStartTime( ) function call. Each CueNode is called in sequence.

Line 7 lists the updateStopTime function, which is called when the parent Score 25 receives an updateStopTime( ) function call. Each CueNode is called in sequence.

Line 8 lists the evaluate function, which is called when the parent Score receives an updateMediaTime function call. Each CueNode is called in sequence and must return its accumulated time. For instance, if offset is 5 and delay is 2, the CueNode would return a value of 7. If offset is −1 and delay is 2, the CueNode would return a value of the incoming accumulated time plus 2. This is the default behavior. Some CueNodes (such as IntervalCue) have a well defined duration as well as a firing time.

In line 9, the getAccumulatedTime function returns the accumulated time using the same calculation as in the evaluate( ) function.

Line 10 lists the fire function, which is called from the default evaluate( ) function when the CueNode reaches its firing time. The fire function is intended to be overridden by the specific derived objects to perform the appropriate action.

The following code portion illustrates the MediaCue node.

1) MediaCue CueNode TimeBaseNode {
2) field Time mediastartTime 0
3) field Time mediaStopTime 0
4) field Time duration 0
5) field Bool isActive false
}

This object controls the advancement of mediaTime when this CueNode is active. MediaCue allows mediaTime to be played over a subset of its range. MediaCue is active from the time determined by the offset and/or delay field for a length of time determined by mediaStopTime minus mediaStartTime. The value MediaCue returns from getAccumulatedTime( ) is the value computed by adding the default function to the mediaStopTime and subtracting the mediaStartTime. This node generates mediaTime while active, which is computed by subtracting the firing time plus mediaStartTime from the incoming mediaTime. MediaCue therefore advances mediaTime at the same rate as the incoming mediatime.

In line 2 of the code portion, the mediaStartTime field sets the start of the sub range of the media duration over which mediaTime runs. The range of mediaStartTime is from zero to the end of the duration (0 . . . duration). If the value of mediaStartTime field is out of range, 0 is utilized in its place.

In line 3, the mediastopTime field sets the end of the sub range of the media duration over which mediaTime runs. The range of mediaStopTime is from zero to the end of the duration (0 . . . duration). If the value of mediaStopTime field is out of range, duration is utilized in its place.

In line 4, the duration field generates an event when the duration of all clients of this TimeBaseNode have determined their duration. The value of duration field is the same as the client with the longest duration.

Line 5 lists the isActive field, which generates a true event when this node becomes active and a false event when this node becomes inactive.

The following code portion illustrates the IntervalCue node.

1) IntervalCue CueNode {
2) field Float period 1
3) field Bool rampup true
4) field Float fraction 0
5) field Bool isActive false
}

This object sends fraction events from 0 to 1 (or 1 to 0 if rampup is false) as time advances. Line 2 of the code snippet lists the period field, which determines the time, in seconds, over which the fraction ramp advances.

In line 3, if the rampUp field is true (the default) the fraction goes up from 0 to 1 over the duration of the IntervalCue. If false, the fraction goes down from 1 to 0. If mediatime is running backwards (when the rate is less than zero), the fraction goes down from 1 to 0 when rampUp field is true, and the fraction goes up from 0 to I when the rampUp field is false.

In line 4, the fraction field sends an event with each call to evaluate( ) while this node is active. If mediaTime is moving forward, fraction starts to output when this node fires and stops when this nodes reaches its firing time plus period. The value of fraction is described as:
fraction=(mediaTime−firing time)*period Eqn. (2)

Line 5 lists the isActive field, which sends a true event when the node becomes active and false when the node becomes inactive. If mediaTime is moving forward, the node becomes active when mediaTime becomes greater than or equal to firing time. This node becomes inactive when mediaTime becomes greater than or equal to firing time plus period. If mediaTime is moving backward, the node becomes active when mediaTime becomes less than or equal to firing time plus period and inactive when mediaTime becomes less than or equal to firing time. The firing of these events is affected by the direction field.

The following code portion illustrates the FieldCue node.

1) FieldCite : CueNode {
2) field Field cueValue NULL
3) field Field cueOut NULL
}

This object sends cueValue as an event to cueOut when FieldCue fires. FieldCue allows any field type to be set and emitted. The cueOut value can be routed to a field of any type. Undefined results can occur if the current type of cueValue is not compatible with the type of the destination field.

In line 2 of the code portion, the cue Value field is the authored value that will be emitted when this node fires. Line 3 lists the cueOut field, which sends an event with the value of cueValue when this node fires.

The following code portion illustrates the TimeCue node.

1) Timecue: CueNode {
2) field Time cueTime 0
}

This object sends the current wall clock time as an event to cueTime when TimeCue fires. Line 2 of the code portion lists the cueTime field, which sends an event with the current wall clock time when this node fires.

The scoring construct within the context of real-time scene composition enables the author to declaratively describe temporal control over a wide range of presentation and playback techniques, including: image flipbooks and image composite animations (e.g., animated GIF); video and audio clips and streams; geometric animation clips and streams, such as joint transformations, geometry morphs, and texture coordinates; animation of rendering parameters, such as lighting, fog, and transparency; modulation of parameters for behaviors, simulations, or generative systems; and dynamic control of asset loading, event muting, and logic functions. For instance, the following example emits a string to pre-load an image asset, then performs an animation using that image, then runs a movie. The string in the following example can also be run in reverse (i.e., first the movie plays backwards then the animation plays backward and then the image disappears).

| | |
|---|---|
| 1) | Score { |
| 2) | timeBase DEF TB TimeBase {} |
| 3) | cue[ |
| 4) | Fieldcue { |
| 5) | cueValue String “” |
| 6) | cueout TO ISURF.URL |
| 7) | direction −1 |
| 8) | } |
| 9) | FieldCue { |
| 10) | cueValue String “imagel.png” |
| 11) | cutOut TO ISURF.url |
| 12) | direction −10 |
| 13) | } |
| 14) | IntervalCue{ |
| 15) | delay 0.5 |
| 16) | period 2.5 # 2.5 second animation |
| 17) | Fraction TO Plfraction |
| 18) | } |
| 19) | DEF MC MediaCue { |
| 20) | offset 2 |
| 21) | } |
| 22) | Fieldcue { |
| 23) | cueValue String “” |
| 24) | cueOut TO ISURF.URL |
| 25) | direction −1 |
| 26) | delay −0.5 |
| 27) | } |
| 28) | Fieldcue { |
| 29) | cue Value String “imagel.png” |
| 30) | cueOut TO ISURF.URL |
| 31) | direction −1 |
| 32) | delay −0.5 |
| 33) | } |
| 34) | ] |
| 35) | } |
| 36) | # Slide out image |
| 37) | DEFT Transform { |
| 38) | children Shape { |
| 39) | appearance Appearance { |
| 40) | texture Texture { |
| 41) | surface DEF ISURF ImageSurface { } |
| 42) | } |
| 43) | } |
| 44) | geometry IndexedFaceSet {...} |
| 45) | } |
| 46) | } |
| 47) | DEF P1 PositionInterpolator |
| 48) | key... |
| 49) | keyValue... |
| 50) | value TO T.translation |
| 51) | } |
| 52) | # Movie |
| 53) | Shape { |
| 54) | appearance Appearance { |
| 55) | texture Texture { |
| 56) | surface MovieSurface { |
| 57) | url “myMovie.mpg” |
| 58) | timeBase USE MC |
| 59) | } |
| 60) | } |
| 61) | } |
| 62) | geometry IndexedFaceSet {...} |
| 63) | } |

In one embodiment, the Cue nodes in a Score fire relative to the media time of the TimeBase, providing a common reference and thereby resulting in an accurate relationship between timing of various media assets. In the code snippet above, the FieldCue (line 9) fires as soon as the TimeBase starts because this FieldCue has default offset and delay fields thereby making the image appear. Lines 35-45 of the code portion loads the image (500, FIG. 5) on a surface. The IntervalCue (line 13) then starts 0.5 seconds later and runs for the next 2.5 seconds, increasing its fraction output from 0 to 1. The firing of the IntervalCue starts the animation (502, FIG. 5) of the image. Lines 46-50 control the animation. The MediaCue (line 18) starts 2 seconds after the TimeBase starts, or when the IntervalCue is 1.5 seconds into its animation thereby starting the movie.

Lines 51-62 load the first frame (504, FIG. 5) of the movie on the surface. When this string is played backwards, first the movie plays in reverse. Then 0.5 seconds later the image appears, and 0.5 seconds after the image appears the animation starts. Animation is played in reverse for 2.5 seconds, when it stops and 0.5 seconds after that the image disappears. This example shows the ability of the Cues to be offset from each other or from the TimeBase and shows that a subsequent Cue can start before the last one has finished.

In one embodiment, the MediaCue gives a synchronization tool to the author. A MediaCue is a form of a Cue, which behaves similar to a TimeBase. In fact, in some instances, a MediaCue can be used where a TimeBase can, as shown in the above example. However, since a MediaCue is embedded in a timed sequence of events, an implementation has enough information to request pre-loading on an asset.

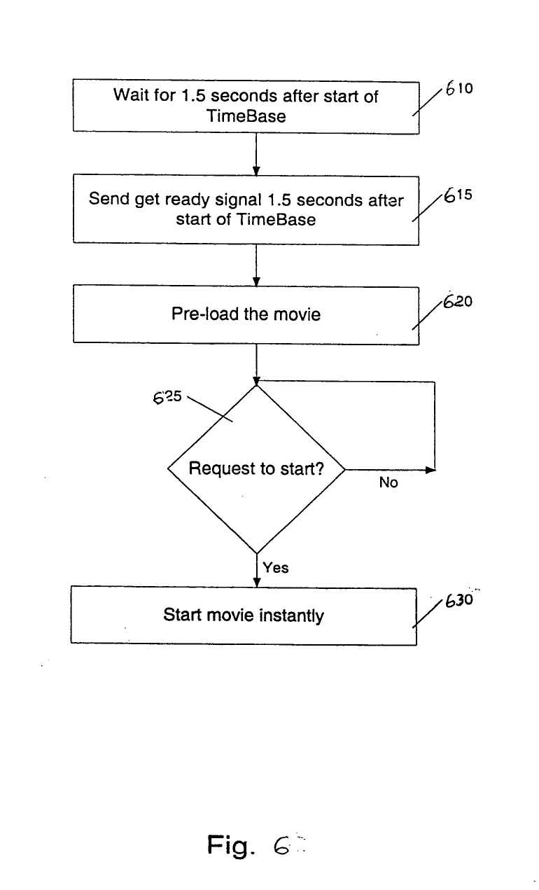

FIG. 6 illustrates synchronization of the media sequence of FIG. 5 utilizing a preloading function. For instance, in the above example, if the implementation knows that a movie takes 0.5 seconds to pre load and play instantly, after waiting (Block 610) 1.5 seconds after the start of the TimeBase, in Block 615, a “get ready” signal is sent to the MovieSurface. Upon receipt of get ready signal, in Block 620 the movie is pre-loaded. This would provide the requested 0.5 seconds to pre-load.

In Block 625, a request to start is received, and upon receipt of the request to start, Block 630 starts the movie instantly.

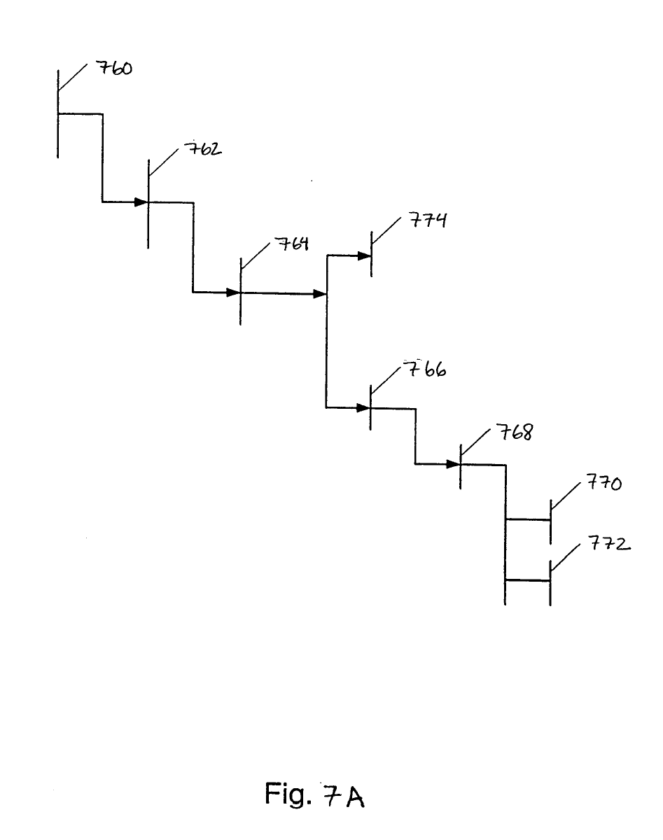

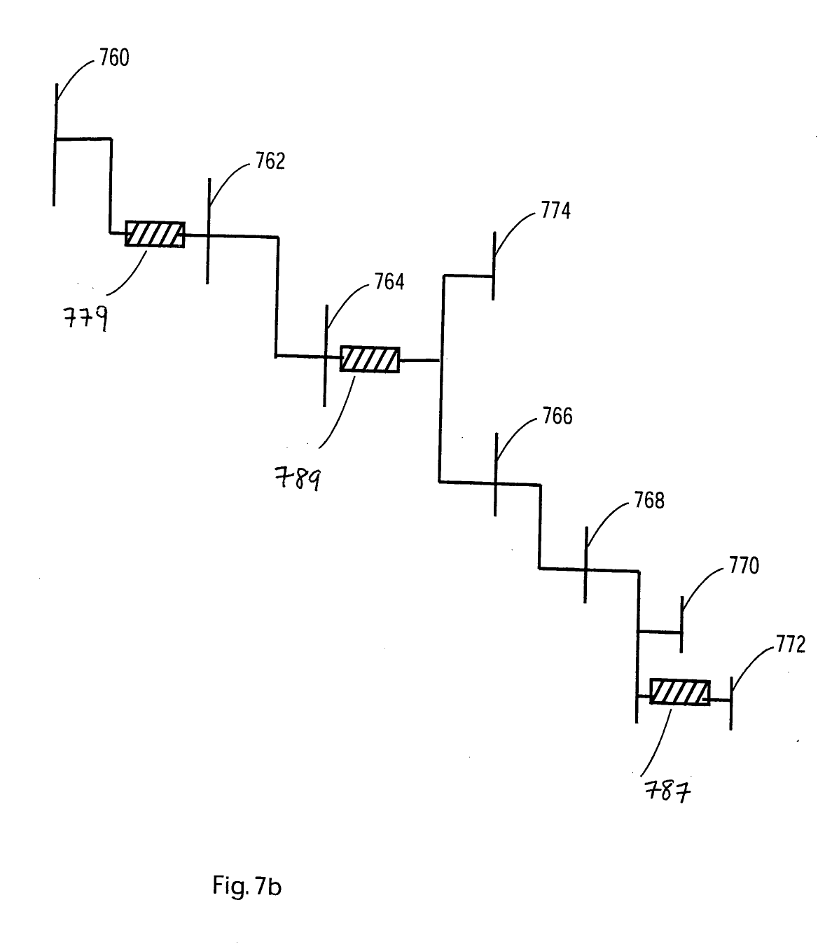

The combination of the TimeBase and media sequencing capabilities allowed in the system 411 makes it possible to create presentations with complex timing. FIG. 7A shows time relationships of various components of the system 411. A viewer, upon selecting news presentation (760), sees a screen wherein he can select a story (762). Upon the user selecting story S3 from a choice of five stories S1, S2, S3, S4 and S5, a welcome screen with an announcer is displayed (764). On the welcome screen the viewer can choose to switch to another story (774) thereby discontinuing story S3. After the welcome statement, the screen transitions to the site of the story (766) and the selected story is played (768). At this point, the viewer can go to the next story, the previous story, rewind the present story or select to play an extended version of story (770) S3 or jump to (772), for example, another story S5. After the selected story is played the user can make the next selection.

The integration of surface model with rendering production and texture consumption allows nested scenes to be rendered declaratively. Recomposition of subscenes rendered as images enables open-ended authoring. In particular, the use of animated sub-scenes, which are then image-blended into a larger video context, enables a more relevant aesthetic for entertainment computer graphics. For example, the image blending approach provides visual artists with alternatives to the crude hard-edged clipping of previous generations of windowing systems.

FIG. 7B shows time relationships of various components of the system 411. Similar to FIG. 7A, a viewer, upon selecting news presentation (760), sees a screen wherein he can select a story (762). The welcome screen with an announcer is displayed (764). On the welcome screen the viewer can choose to switch to another story (774) thereby discontinuing story S3. After the welcome statement, the screen transitions to the site of the story (766) and the selected story is played (768). At this point, the viewer can go to the next story, the previous story, rewind the present story or select to play an extended version of story (770) S3 or jump to (772), for example, another story S5. After the selected story is played the user can make the next selection.

In addition, TimeBase also allows a “stopping time” function that pauses the current actions to occur. By pausing the current actions, the clock is temporarily stopped. In one embodiment, pausing the current action allows debugging operations to be performed. In another embodiment, pausing the current actions allows the viewer to experience the current actions at a slower pace.

In one embodiment, a stop block (779) is utilized to pause the display of various selections after the selection of the news presentation (760) and prior to the display of the screen to select the story (762). In another embodiment, a stop block (789) is utilized to pause the display of a user's choice prior to a selection being made. For example, the stop block (789) allows the possible selections to be presented on the welcome screen (764) and prevents the selection of the story (774) or the story (766). In another embodiment, a stop block (787) is utilized to pause the display content (772) after the choice for the content (772) has been selected.

In one embodiment, the stop blocks (779, 789, and 787) pauses the action for a predetermined amount of time. In another embodiment, the stop blocks (779, 789, and 787) pauses the action until additional input is received to resume the action.

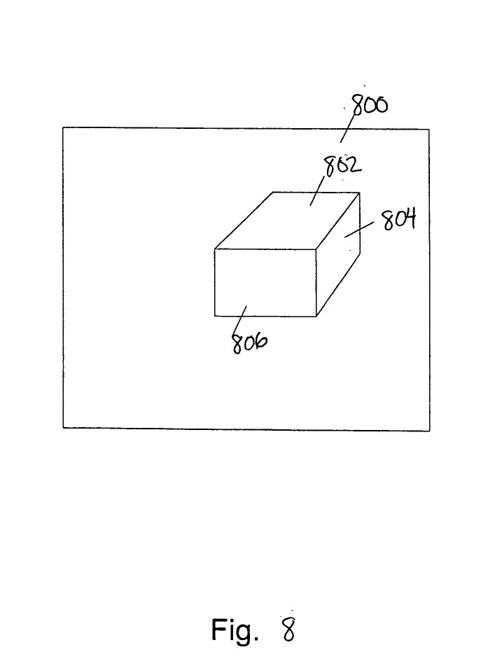

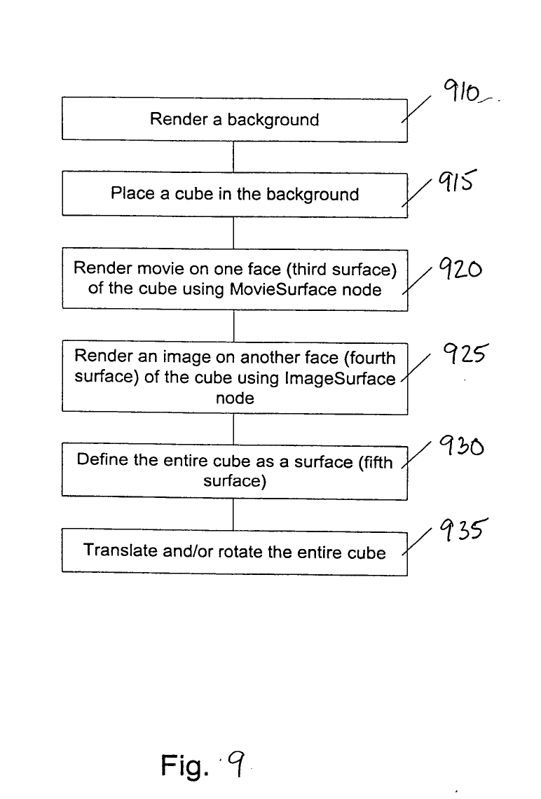

FIG. 8 depicts a nested scene including an animated sub-scene. FIG. 9 is a flow diagram showing acts performed to render the nested scene of FIG. 7. Block 910 renders a background image displayed on screen display 800, and block 915 places a cube 802 within the background image displayed on screen display 800. The area outside of cube 802 is part of a surface that forms the background for cube 802 on display 800. A face 804 of cube 802 is defined as a third surface. Block 920 renders a movie on the third surface using a MovieSurface node. Thus, face 804 of the cube displays a movie that is rendered on the third surface. Face 806 of cube 802 is defined as a fourth surface. Block 925 renders an image on the fourth surface using an ImageSurface node. Thus, face 806 of the cube displays an image that is rendered on the fourth surface. In block 930, the entire cube 802 is defined as a fifth surface and in block 935 this fifth surface is translated and/or rotated thereby creating a moving cube with a movie playing on face 804 and a static image displayed on face 806. A different rendering can be displayed on each face of cube 802 by following the procedure described above. It should be noted that blocks 910 to 935 can be done in any sequence including starting all the blocks 910 to 935 at the same time.

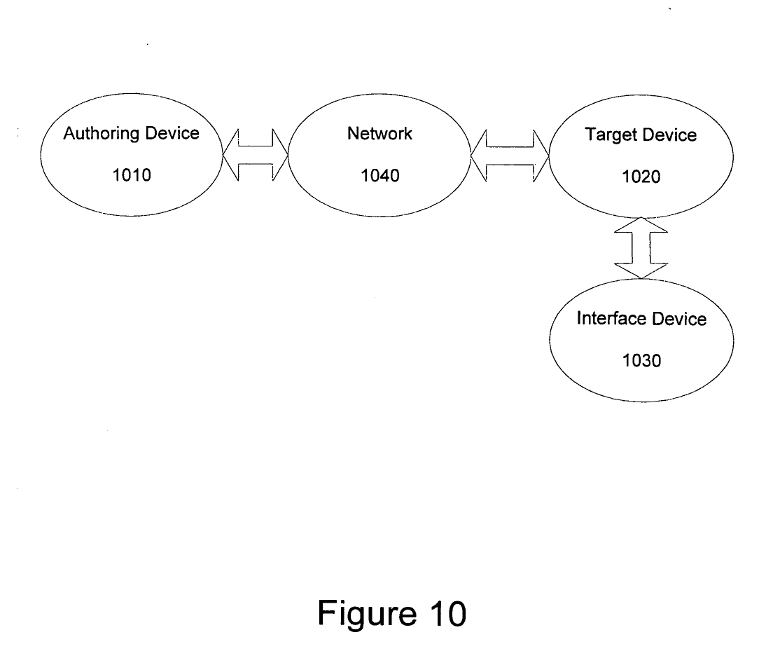

FIG. 10 illustrates an exemplary block diagram illustrating an exemplary architecture in which a system 1000 for authoring declarative content for a remote platform is implemented. In one embodiment, the system 1000 includes an authoring device 1010, a target device 1020, an interface device 1030, and a network 1040. In one embodiment, the network 1040 allows the authoring device 1010, the target device 1020, and the interface device 1030 to communicate with each other.

In one embodiment, the authoring device 1010 includes an authoring application that allows the user to create the authored content through a declarative language as illustrated by the code snippets above. In one embodiment, a file server (such as Apache and Zope) runs on the authoring device 1010 and supports a local file system.

In one embodiment, the target device 1020 communicates with the authoring device 1010 and receives the authored content that is scripted on the authoring device 1010.

In one embodiment, the interface device 1030 plays the authored content through the remote device 1020. The interface device 1030 may include a visual display screen and/or audio speakers.

In one embodiment, the network 1040 is the internet. In one embodiment, the communication between the authoring device 1010 and the remote device 1020 is accomplished through TCP/IP sockets. In one embodiment, the authored content is requested by the remote device 1020 from the authoring device 1010 via TCP/IP and are provided to the target through HTTP.

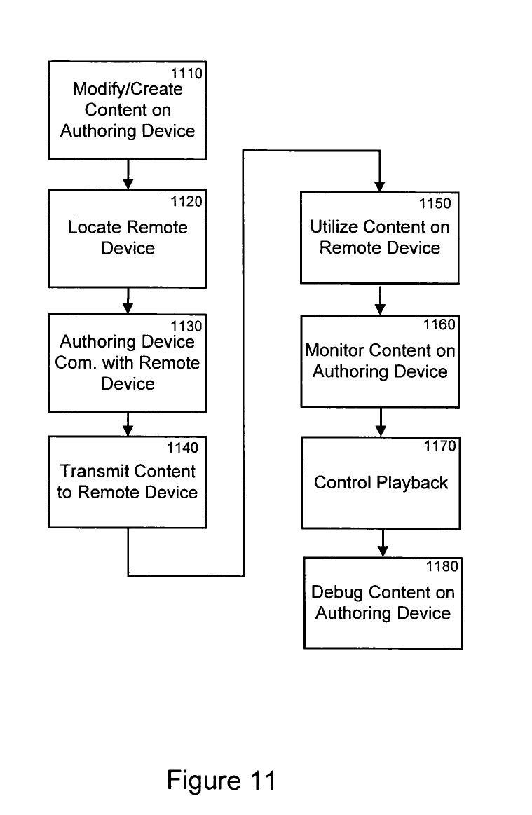

The flow diagram as depicted in FIG. 11 is one embodiment of the methods and apparatuses for authoring declarative content for a remote platform. The blocks within the flow diagram can be performed in a different sequence without departing from the spirit of the methods and apparatuses for posting messages to participants of an event. Further, blocks can be deleted, added, or combined without departing from the spirit of the methods and apparatuses for authoring declarative content for a remote platform. In addition, blocks can be performed simultaneously with other blocks.

The flow diagram in FIG. 11 illustrates authoring declarative content for a remote platform according to one embodiment of the invention.

In Block 1110, authored content is modified or created on an authoring device. In one embodiment, the authoring device is a personal computer utilizing an operating system such as Windows®, Unix®, Mac OS®, and the like. In one embodiment, the authoring device utilizes a declarative language to create the authored content. One such declarative language is illustrated with code snippets shown above within the specification. Further, the authored content that is created on the authoring device is specifically developed for use on the remote device such as a gaming console, a cellular telephone, a personal digital assistant, a set top box, and the like.

In one example, the authored content is configured to display visual images on the remote device. In another example, the authored content is configured to play audio signals on the remote device. In yet another embodiment, the authored content is configured to play both the visual images and audio signals simultaneously.

In Block 1120, the remote device is detected. In one embodiment, communication parameters of the remote device are detected such as the specific TCP/IP socket(s).

In Block 1130, the authoring device is in communication with the remote device. In one embodiment, the authoring device directly communicates with the remote device through a direct, wired connection such as a cable. In another embodiment, the authoring device communicates with the remote device through a network such as the Internet, a wireless network, and the like.

In Block 1140, the authored content is transmitted from the authoring device to the remote device. In one embodiment, the authored content is transmitted to the remote device as a data stream.

In Block 1150, the authored content is utilized through the remote device. In one embodiment, the remote device visually displays the authored content utilizing the remote device. In another embodiment, the remote device plays the audio signal of the authored content. In one embodiment, the authored content is utilized on the interface device 1030. In one embodiment, the remote device commences utilizing the authored content as the authored content is streamed to the remote device. In another embodiment, the remote device utilizes the authored content after the authored content is transmitted to the remote device.

In one embodiment, a portion of the authored content is utilized on the remote device simultaneously as the remaining authored content is being transmitted to the remote device in the Block 1140.

In Block 1160, the authoring device monitors the authored content as the authored content is utilized by the remote device. For example, the authoring device tracks a specific portion of the authored content that corresponds with the authored content displayed on the remote device. In another example, the authoring device monitors the authored content utilized by the remote device simultaneously as a portion of the authored content is still being transmitted to the remote device in the Block 1140.

In Block 1170, the authoring device controls the playback of the authored content on the remote device. For example, the authoring device is capable of pausing, rewinding, forwarding, and initiating the playback of the authored content on the remote device remotely from the authoring device.

In Block 1180, the authoring device debugs the authored content. In one embodiment, the authoring device debugs the authored content by viewing the scripting of the authored content on the authoring device while experiencing the playback of the authored content on the remote device. In another embodiment, the authoring device pauses the playback of the authored content on the remote device while debugging the corresponding scripting of the authored content on the authoring device. For example, while the authored content is paused on the remote device, the corresponding authored content is monitored and available on the authoring device to be modified and/or debugged.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method comprising:
transmitting authored content from an authoring device to a remote device;
directly playing the authored content on the remote device; and
monitoring a portion of the authored content on the authoring device while simultaneously playing the portion of the authored content on the remote device,
wherein the authored content is scripted in a declarative markup language.

2. The method according to claim 1 further comprising modifying the portion of the authored content on the authoring device while simultaneously playing the portion of the authored content on the remote device.

3. The method according to claim 1 wherein directly playing further comprises displaying a plurality of images corresponding to the authored content.

4. The method according to claim 1 wherein directly playing further comprises playing an audio signal corresponding to the authored content.

5. The method according to claim 1 further comprising creating the authored content on the authoring device.

6. The method according to claim 5 wherein creating the authored content further comprises utilizing a tool resident on the authoring device to create the authored content.

7. The method according to claim 6 wherein the tool is a (example here).

8. The method according to claim 1 further comprising debugging the portion of the authored content on the authoring device while simultaneously playing the portion of the authored content on the remote device.

9. The method according to claim 1 further comprising controlling the authored content on the remote device from the authoring device.

10. The method according to claim 9 wherein controlling the authored content further comprises initiating playback of the authored content on the remote device.

11. The method according to claim 9 wherein controlling the authored content further comprises pausing playback of the authored content on the remote device.

12. The method according to claim 9 wherein controlling the authored content further comprises fast forwarding a playback location of the authored content on the remote device.

13. The method according to claim 9 wherein controlling the authored content further comprises rewinding a playback location of the authored content on the remote device.

14. The method according to claim 1 wherein the remote device is one of a gaming console, a cellular telephone, a personal digital assistant, a set top box, and a pager.

15. The method according to claim 1 wherein the authoring device is a personal computer.

16. A system comprising:
means for transmitting authored content from an authoring device to a remote device;
means for directly playing the authored content on the remote device; and
means for monitoring a portion of the authored content on the authoring device while simultaneously playing the portion of the authored content on the remote device,
wherein the authored content is scripted in a declarative markup language.

17. A method comprising:
modifying authored content on an authoring device wherein the authored content is scripted in a declarative markup language;
transmitting the authored content from the authoring device to a remote device; and
playing a portion of the authored content on the remote device while simultaneously transmitting the authored content from the authoring device to the remote device.

18. The method according to claim 17 further comprising monitoring the portion of the authored content on the authoring device while simultaneously playing the portion of the authored content on the remote device.

19. The method according to claim 17 further comprising debugging the portion of the authored content on the authoring device while simultaneously playing the portion of the authored content on the remote device.

20. The method according to claim 17 wherein playing further comprises displaying a plurality of images corresponding to the authored content.

21. The method according to claim 17 wherein directly playing further comprises playing an audio signal corresponding to the authored content.

22. The method according to claim 1 further comprising creating the authored content on the authoring device.

23. The method according to claim 22 wherein creating the authored content further comprises utilizing a tool resident on the authoring device to create the authored content.

24. The method according to claim 23 wherein the tool is a (example here).

25. The method according to claim 17 further comprising controlling the authored content on the remote device from the authoring device.

26. The method according to claim 25 wherein controlling the authored content further comprises initiating playback of the authored content on the remote device.

27. The method according to claim 25 wherein controlling the authored content further comprises pausing playback of the authored content on the remote device.

28. The method according to claim 25 wherein controlling the authored content further comprises fast forwarding a playback location of the authored content on the remote device.

29. The method according to claim 25 wherein controlling the authored content further comprises rewinding a playback location of the authored content on the remote device.

30. The method according to claim 17 wherein the remote device is one of a gaming console, a cellular telephone, a personal digital assistant, a set top box, and a pager.

31. The method according to claim 17 wherein the authoring device is a personal computer.

32. A system, comprising:
an authoring device to modify authored content wherein the authored content is scripted in a declarative markup language;
a remote device configured to play the authored content; and
a network configured to stream the authored content from the authoring device to the remote device,
wherein an initial portion of the authored content is simultaneously utilized by the remote device while a remaining portion of the authored content is streamed to the remote device.

33. The system according to claim 32 further comprising a storage module within the remote device to buffer the authored content received by the remote device.

34. The system according to claim 32 wherein the remote device is one of a gaming console, a cellular telephone, a personal digital assistant, a set top box, and a pager.

35. The system according to claim 32 wherein the authoring device is a personal computer.

36. The system according to claim 32 wherein the network is the internet.

37. A computer-readable medium having computer executable instructions for performing a method comprising:
modifying authored content on an authoring device wherein the authored content is scripted in a declarative markup language;
transmitting the authored content from the authoring device to a remote device; and
playing a portion of the authored content on the remote device while simultaneously transmitting the authored content from the authoring device to the remote device.
